(19) United States
(12) Patent Application Publication
(10) Pub. No.: US 2023/0256734 A1
(43) Pub. Date: Aug. 17, 2023

(54) DETECTING PRINTHEAD ISSUES

(71) Applicant: Hewlett-Packard Development Company, L.P., Spring, TX (US)

(72) Inventors: Mohammad Jowkar, Sant Cugat del Valles (ES); Luis Garcia Garcia, Sant Cugat del Valles (ES); Rhys Mansell, Sant Cugat del Valles (ES)

(73) Assignee: Hewlett-Packard Development Company, L.P., Spring, TX (US)

(21) Appl. No.: 18/012,041

(22) PCT Filed: Jul. 8, 2020
(86) PCT No.: PCT/US2020/041130

§ 371 Date: Dec. 21, 2022

(51) Int. Cl. B41J 2/045

(52) U.S. Cl. CPC B41J 2/04558; B41J 2/04586

(57) ABSTRACT

According to one aspect, there is provided a method of detecting printhead issues in a printer. The method comprises obtaining an image to be printed, generating a first sub-pattern and a second sub-pattern, wherein the first sub-pattern in a pattern to be printed in a first pass comprising a pattern suitable to enable the detection of a printhead issue and wherein the second sub-pattern is the complementary pattern that completes the first sub-pattern such that printing the first and second sub-patterns is equivalent to printing the obtained image, printing the first sub-pattern on a print target, obtaining an image of the printed first sub-pattern, analysing the image of the printed first sub-pattern to determine the presence of a printhead issue and, where appropriate, performing a printhead maintenance operation, and printing the second sub-pattern on the print target.

### BACKGROUND

Many printers use a printhead comprising a precision array of nozzles, for example having between 600 to 2400 nozzles per inch, to deposit printing liquids onto a target to generate a high definition printed pattern. In two-dimensional printers a target may be a substrate, such as a sheet of print media, and the printed pattern may represent text or graphical based information. In three-dimensional printers a target may be a layer of powder, such as a layer of plastic, metal, or ceramic powder, and the printed pattern may represent a cross-section of a layer of a three-dimensional object to be formed by the printer.

The quality of printed output depends on each of the printhead nozzles correctly functioning during the execution of a print job. In printers that use an array of printheads or dies, the quality of printed output additionally depends at least partially on a suitable alignment of nozzles on the printheads or dies during the execution of a print job.

### BRIEF DESCRIPTION

Examples will now be described, by way of non-limiting example only, with reference to the accompanying drawings, in which:

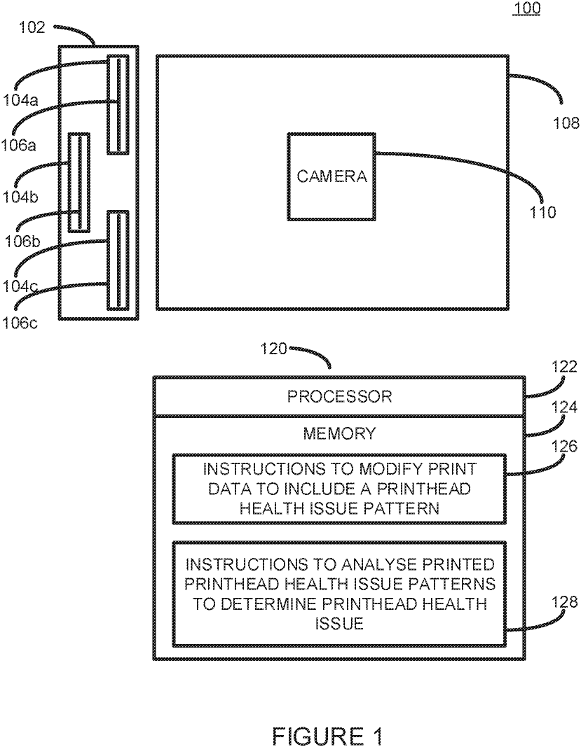

FIG. 1 is a schematic diagram shown a printing system according to one example;

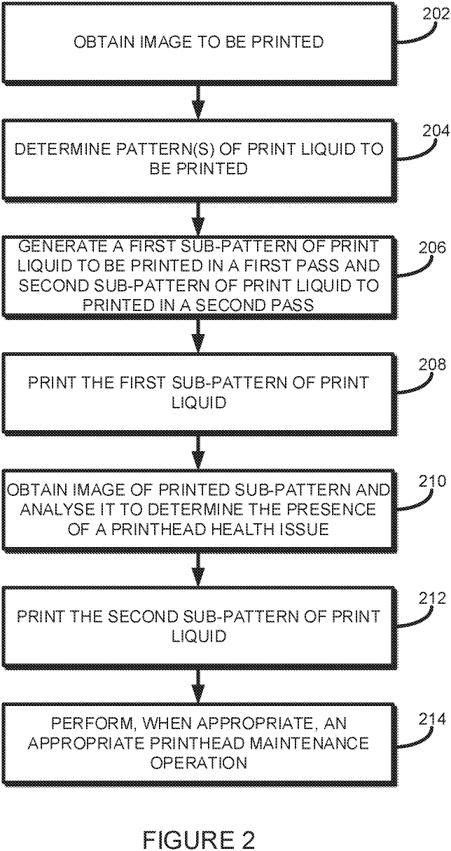

FIG. 2 is a flow diagram outlining an example method of operating a printing system;

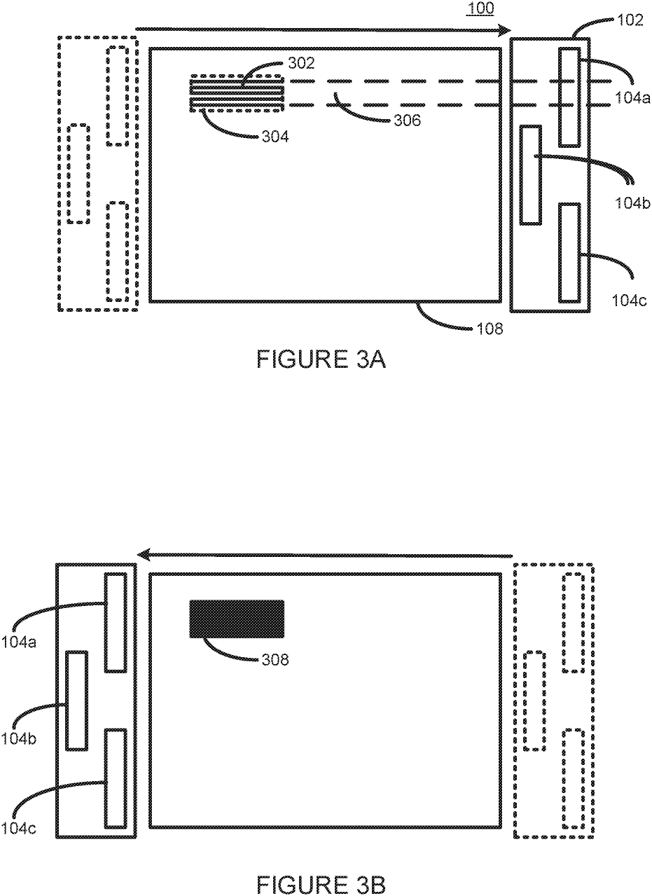

FIGS. 3A and 3B are schematic diagrams showing operation of a printing system according to an example;

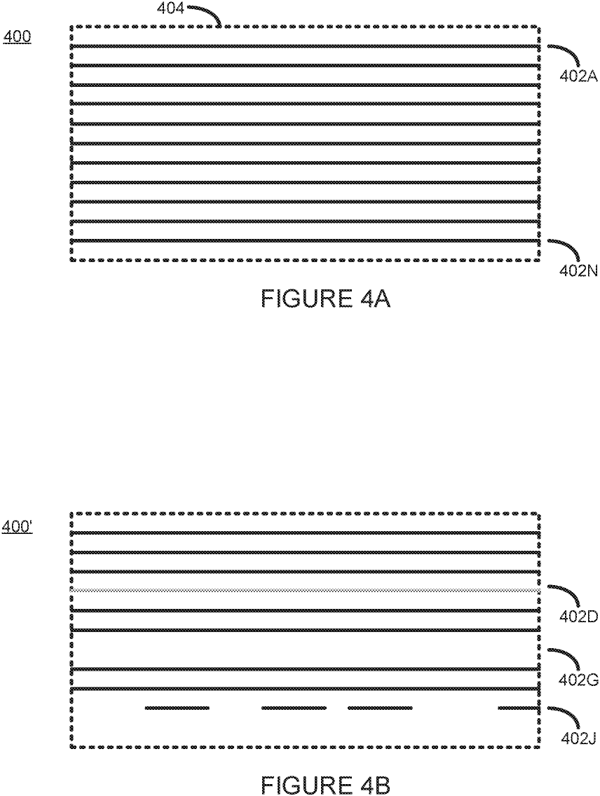

FIG. 4A is an illustration of a first sub-pattern according to one example;

FIG. 4B is an illustration of a first sub-pattern as printed according to one example;

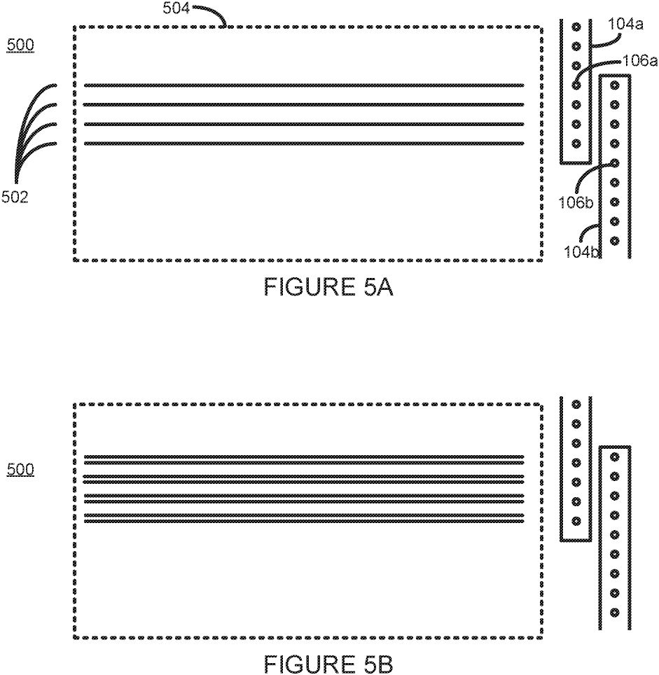

FIG. 5A is an illustration of a first sub-pattern according to one example;

FIG. 5B is an illustration of a first sub-pattern as printed according to one example; and

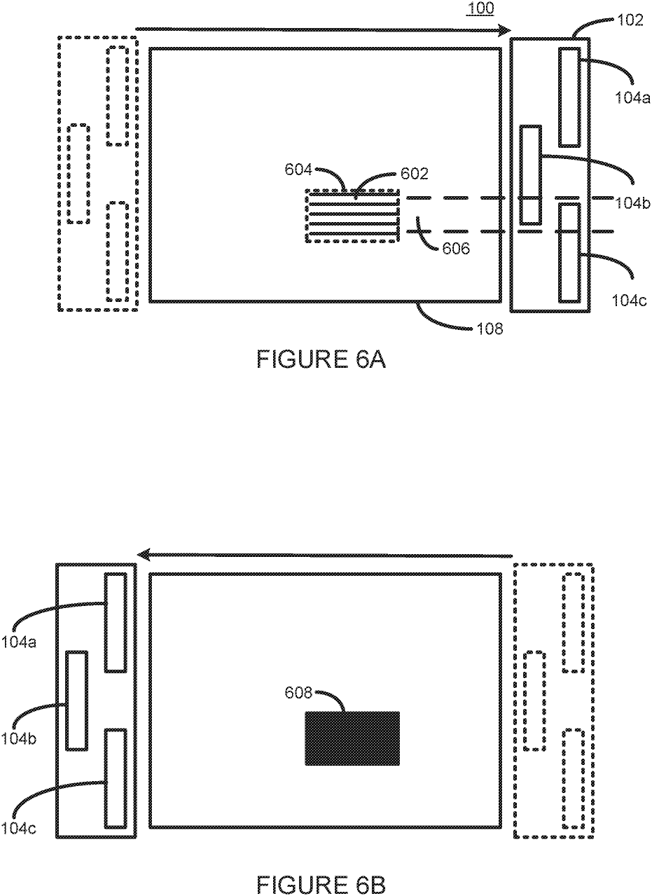

FIGS. 6A and 6B are schematic diagrams showing operation of a printing system according to an example.

### DETAILED DESCRIPTION

In some printing systems the correct functioning of printhead nozzles may be tested by using printhead drop detectors. Such drop detectors work by using a light source and a light sensor to detect the presence of an in-flight drop of printing liquid ejected by a printhead nozzle into the drop detector. If a problem, such as blocked nozzle, is detected a maintenance operation, such as a printhead wipe or a nozzle purge, may be performed to alleviate the problem.

In printers that use an array of printheads, or an array of printhead dies, the printheads are typically arranged in a semi-overlapping configuration, such that a set of nozzles from one printhead overlap along the nozzle axis with a set of nozzles from an immediately adjacent printhead. This overlapping configuration is used to help mask print quality artifacts that may occur in the region of adjacent printheads. The nozzle overlap region of each printhead may typically comprise around 100 nozzles or less. Nozzle alignment tests may be performed by printing a test pattern and then analyzing the test pattern to determine whether printhead nozzles in a printhead overlap region are correctly aligned. Nozzle mis-alignment problems may generally be remedied by modifying printhead firing signals, for example by shifting firing signals intended for one nozzle to another nozzle. Since nozzle alignment verification involves a test pattern being printed, nozzle alignment tests may only be performed periodically.

In two-dimensional printers drop detectors may be used during execution of a print job. However, in some three-dimensional printers use of drop detection may not be possible during the execution of a print job. This may be the case, for example, in printers that use warming or fusing lamps to warm and/or thermal fuse (e.g. melt) portions of powder on which a liquid fusing agent has been applied, as drop detectors cannot be used in the presence of such lamps. Furthermore, in some such systems warming and/or fusing lamps may be illuminated for long periods throughout the duration of a print job, making use of drop detectors impractical.

Execution of a three-dimensional print job may comprise printing patterns on hundreds or thousands of layers of powder which may take from many tens of minutes to many hours to complete. In printers that operate in relatively hot environments, such as three-dimensional printers where a build chamber may be heated, for example in excess of 100 Celsius, thermal expansion may cause misalignment of different printheads or dies relative to each other during execution of a print job, which in turn may cause nozzle misalignment issues. If a nozzle misalignment occurs during printing of a three-dimensional print job, the consequences may not be known until the print job has finished, which may be many hours later and after which a significant volume of powder build material and print liquids may have been used. In the case of a problem, objects generated by the print job which were affected by the nozzle misalignment may be of a poor quality, which may result in significant quantities of waste.

Examples described herein provide a method and a system for detecting printhead maintenance issues during the execution of a print job. Some examples also provide for correction of any such issues during the execution of a print job.

Referring now to FIG. 1 there is shown a printing system 100 according to one example. The printing system 100 comprises a carriage 102 on which are mounted an array of printheads 104. Each printhead 104 comprises a set of printhead nozzles 106 (illustrated as a solid line) aligned with a longitudinal printhead axis through each of which a printing liquid may be ejected, in accordance with print data, onto a target 108. Each printhead may comprise a highly dense configuration of nozzles to enable high-resolution printing, for example at a resolution of 600 to 2400 dpi (dots per inch). The number of nozzles on each printhead may vary depending on the chosen length of the printhead. In this example, the set of nozzles 106 are part of the same print liquid channel, meaning that each of the nozzles in the set of nozzles 106 are capable of ejecting drops of a single printing liquid associated with the channel. In other examples, each printhead may comprise a plurality of sets of nozzles, each set of nozzles being associated with a different print liquid channel. Examples of different kinds of printing liquids include different coloured inks (e.g. black ink, magenta ink, cyan ink, yellow ink, etc.) and different three-dimensional printing liquids such as fusing agent, detailing agent, binder agent, etc.

The array of printheads 104 span a width of the print target 108 to enable printing along the whole width of the target 108.

The carriage 102 is translatable relative to the target 108 to allow printing along the whole length of the target 108. In one example the carriage 102 may move over the target 108 which remains static, although in another example the carriage 102 may be remain static and the target 108 may move under the carriage 102.

In one example, the printing system 100 is a two-dimensional printing system in which the target 108 is a print media or substrate, such as a sheet of paper or other suitable media. In another example, the printing system 100 is a three-dimensional printing system in which the target 108 is a layer of a powder build material, such as a powdered plastic, metal, or ceramic build material. The layer of powder may be formed on a movable build platform that is part of a build chamber in which three-dimensional objects may be generated. Common features of printing systems, such as media handling systems, powder layering systems, heating systems, printing agent supply systems, etc. are not shown in the accompanying drawings for reasons of clarity.

Positioned above the print target 108 is a camera 110, or other suitable vision system, for capturing images of printing liquids that have been printed onto the print target 108.

Operation of the printing system 100 is controlled by a controller 120. The controller 120 comprises a processor 122, such as a microprocessor or microcontroller that is coupled to a memory 124. On the memory 124 are stored computer readable instructions 126 to cause, upon execution, the printing system to modify print data to include a printhead health issue pattern, and instructions 128 to cause the printing system 100 to analyse a printed printhead health issue pattern to determine whether a printhead health issue exists. The controller 120 is to execute the instructions 126 and 128 to cause the printing system 100 to operate in accordance with the method described below and as shown in FIG. 2, and with further reference to FIGS. 3A, 3B, 4A, 4B, 5A, 5B, 6A, and 6B.

At block 202, the controller 120 obtains image data of an image to be printed. In a two-dimensional printer the image to be printed may comprise, for example, a photograph, a graphic, text, etc. to be printed on a sheet of media. In a three-dimensional printer the image to be printed may comprise, for example, a set of images each defining a layer, or cross-section, of one or more three-dimensional objects to be formed in a particular layer of build material. A suitable process, such as applying fusing energy to the layer of build material on which an object cross-section is printed, causes the object cross-section to be physically formed, for example through melting, coalescence, and solidification upon cooling of a powder build material.

At block 204, the controller 120 determines a complete pattern of print liquid to be printed to completely form the image to be printed. This may involve, for example, converting a digital image into halftone data, or converting an image of a slice of a three-dimensional model of an object to be generated into patterns of one or more of a pattern of fusing agent, a pattern of detailing agent, a pattern of binder agent, etc.

At block 206, the controller 120 generates a first sub-pattern of print liquid to be printed in a first pass of the carriage over the print target 108, and a second sub-pattern of print liquid to be printed in a second or subsequent pass of the carriage 102 over the print target 108. The first sub-pattern is a subset of the complete pattern of printing liquid to be printed, and the second sub-pattern is the complementary pattern that completes the first sub-pattern such that printing of the first and second sub-patterns on the print target is equivalent to printing the complete pattern on the print target.

The first sub-pattern is generated to produce, when printed, a pattern that can be imaged by the camera 110 and analysed by the controller 120 to determine one or multiple printhead health issues with the printhead, or with nozzles on the printhead, that printed the pattern. The type of pattern generated may depend on the position of the first sub-pattern relative to a set of overlapping printhead nozzles. For example, if the image to be generated on the target 108 is to be generated by a set of printhead nozzles that are not in the overlapping region of a printhead, the first sub-pattern generated may be a pattern that enables detection of a blocked or mis-firing nozzle. An example first-sub pattern is illustrated in FIG. 4A, although in other examples other types of patterns may be used. If, however, the image is to be generated by a set of overlapping printhead nozzles, the first sub-pattern may be either a pattern to enable detection of a blocked or a mis-firing nozzle (as illustrated in FIG. 4A), or it may be a pattern to enable detection of nozzle alignment between overlapping nozzles of two adjacent printheads (as illustrated in FIG. 5A). The precise pattern of the first sub-pattern may be adapted based on the content of the complete pattern to be printed, such that the first sub-pattern is only printed in regions that correspond to regions of the complete pattern.

The example first sub-pattern 400 shown in FIG. 4A comprises a series of parallel lines 402A to 402N, each spanning the length of the complete pattern 404. The first sub-pattern 400 is contained within the border of the complete pattern 404, shown in dotted line. In one example, each line has a thickness that will result in it being printed by a single printhead nozzle. The lines 402A to 402N may, for example, by aligned such that they will be printed by non-immediately adjacent nozzles. In one example the lines 402 may be aligned such that they are printed by every other nozzle, or every third nozzle, or every fourth nozzle, or at any other suitable regular or irregular nozzle spacing.

The example sub-pattern 500 shown in FIG. 5A comprises a set of lines 502 each of which is aligned with a pair of corresponding and overlapping nozzles, as illustrated. The first sub-pattern 500 is contained within the border of the complete pattern 504, shown in dotted line. When the pattern 500 is printed, a printer pipeline (not shown) will cause portions of each line 502 to be printed by different ones of the pair of corresponding and overlapping nozzles. For reference, an illustration of the two printheads 104a and 104b having respective arrays of printhead nozzles 106a and 106b are shown in FIGS. 5A and 5B.

At block 208, the controller 120 controls the printing system 100 to print the generated first sub-pattern 302. A first example is shown in FIG. 3A, and a second example is shown in FIG. 6A. Printing the first sub-pattern 302 involves controlling the carriage 102 to translate over the print target 108 by moving from an initial position (shown in dotted line) to a final position (shown in solid line). The controller 120 controls the printheads 104 to eject print liquid from appropriate nozzles and at appropriate locations on the print target 108 based on printhead firing data generated by the printer pipeline based on the generated first sub-pattern.

In FIG. 3A the outline of the complete pattern to be printed is shown as dotted line 304. Within the boundary of the complete pattern 304 is printed a first sub-pattern 302. As indicated by dashed lines 306, the first sub-pattern 302 is not printed by a set of overlapping nozzles, and hence the first sub-pattern 302 is a pattern suitable to allow the detection of a nozzle health issue, such as a blocked nozzle, or a mis-firing nozzle.

In FIG. 6A the outline of the complete pattern to be printed is shown by dotted line 604. Within the boundary of the complete pattern 604 is printed a first sub-pattern 602. As indicated by dashed lines 606, the first sub-pattern 602 is printed by a set of overlapping nozzles, and the first sub-pattern 602 is a pattern suitable to allow the detection of a nozzle alignment issue, although as described previous a pattern suitable to detect the health of a nozzle may alternatively be used in this region.

At block 210, the controller 120 controls the printing system 100 to obtain, using the camera 110, an image of printed first sub-pattern (302, 602) and to analyse the obtained image to determine the presence of a printhead health issue. As described further below, this may comprise comparing an image obtained by the camera 110 of the printed first sub-pattern (302, 602) and comparing it with the first sub-pattern as it was intended to be printed. Any discrepancies between the two may be indicative of a printhead nozzle issue.

FIG. 4B illustrates an image captured by the camera 110 of the result of printing the first sub-pattern 400 on the target 108. As can be seen, a number of the printed lines exhibit defects. For example, the line 402D is relatively faint, which is indicative that the nozzle that printed it may be at least partially blocked or is otherwise misfiring. The line 402G is missing, indicating that the nozzle that was to print it is blocked, and the line 402J is not continuous, indicating that the nozzle that printed it was at least partially blocked or misfiring.

FIG. 5B illustrates an image captured by the camera 110 of the result of printing the first sub-pattern 500 on the target 108. As can be seen, a number of pairs of lines have been printed, whereas in FIG. 5A the first sub-pattern 500 defines only a set of single lines. The generated of the pairs of lines is indicative of a misalignment between nozzles on adjacent printheads, as illustrated on the right-hand side of FIG. 5B.

At block 212, the controller 120 controls the printing system 100 to print the second generated sub-pattern to complete the complete pattern to be printed. This is illustrated in FIG. 3B and in FIG. 6B. This involves controlling the carriage 102 to translate over the print target 108 by moving from an initial position (shown in dotted line) to a final position (shown in solid line), and controlling the printheads 104 to eject print liquid from appropriate nozzles and at appropriate locations on the print target 108 based on printhead firing data generated based on the generated second sub-pattern.

At block 214, the controller 120 controls the printing system to perform an appropriate printhead maintenance operation at an appropriate time to remedy the determined printhead heath issue. In one example, block 214 may be performed prior to block 212 to enable correction of any printhead health issues prior to the printing of the second sub-pattern. A suitable printhead maintenance operation may include, for example, a printhead wiping operation, a printhead purging operation, a print data nozzle assignment modification, or the like.

In one example, the first sub-pattern does not have to uniquely comprise a pattern that can be used to determine the presence of a printhead health issue. For example, first sub-pattern may comprise a suitable portion of the complete pattern, and a pattern suitable to allow identification of a printhead health issue. The examples of patterns described herein are merely exemplary, and other patterns, such as patterns of blocks, or lines, suitable for detecting printhead health issues may be used.

Depending on the complete pattern to be printed, the first sub-pattern may comprise a portion suitable to detect nozzle health, and a portion suitable to detect nozzle misalignment.

In one example, the controller 120 keeps a track of the time when the health, and where appropriate the alignment, of each nozzle of each printhead was verified using the techniques described above. In this way, the controller 120 may determine the type of sub-pattern to be used, and the nozzles that are to be used to print it, based on the age of the nozzle verification. Depending on the complete pattern to be printed, it may not be possible to verify the health of all nozzles in a single printing pass. However, by taking into account the nozzle health verification age the controller 120 can ensure that, as far as possible, overtime, as many nozzles as possible have their health verified. In the same manner, the controller 120 may keep a track of whether nozzles in an overlapping region had been verified in terms of both nozzle health, and in terms of nozzle alignment, and the controller 120 may determine the type of first sub-pattern to be printed accordingly.

In one example, use of the above-described techniques may be performed on every layer of powder in a three-dimensional printing system, or on every sheet of media used in a two-dimensional printing system. In other examples, however, the techniques may be used intermittently. For example, some layers or substrates may be printed using a single pass printing process, in which the complete pattern to be printed is printed in a single printing pass, and only intermittent layers or substrates may be printed using two pass printing with a first pass to print a first sub-pattern, and a second pass to print a second sub-pattern. In this way, printing throughput may be maintained at a relatively high level.

In printing systems that use multiple print liquid channels, it may be suitable to verify the alignment of nozzles by printing a first sub-pattern using nozzles from a single one of the channels. This is because nozzle alignment within a single printhead or die is unlikely to change over time. However, it is beneficial to verify the health of all nozzles for all print liquid channels.

The techniques described herein allow for printhead maintenance operations to be performed in a printing system without interrupting a print job.

It will be appreciated that example described herein can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are examples of machine-readable storage that are suitable for storing a program or programs that, when executed, implement examples described herein. Accordingly, some examples provide a program comprising code for implementing a system or method as claimed in any preceding claim and a machine-readable storage storing such a program. Still further, some examples may be conveyed electronically via any medium such as a communication signal carried over a wired or wireless connection.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

1. A system to detect printhead issues in a printer, comprising:
a printhead comprising an array of nozzles through which a printing liquid may be ejected, the printhead mounted on a carriage to move relative to a print target along a print axis;
a vision system to capture images of printing liquid ejected by the printhead onto the target; and
a controller to:
determine a pattern of printing liquid to be ejected by the printheads to form an intended pattern on the target;
generate two complementary patterns of printing liquid, a first complementary pattern to be formed on the target during a first pass of the printheads over the target, and a second pattern to be formed on the target during a second pass of the printheads over the target, such that the formation of the two patterns on the target forms the intended pattern, the first complementary pattern being formed to include a pattern to enable detection of a printhead service issue;
cause the printhead to print the first complementary pattern on the target;
detect, using an image of the printed first complementary pattern obtained from the vision system, whether a printhead service issue exists;
cause the printhead to print the second complementary pattern on the target to complete formation of the intended pattern;
and if it is determined that a printhead service issue exists perform a printhead maintenance operation to address the printhead service issue.

2. The system of claim 1, wherein the controller is to generate the first complementary pattern the printing of which is suitable to enable the detection of a nozzle health issue.

3. The system of claim 1, wherein the printer comprises an array of semi-overlapping printheads or printhead dies, and wherein the controller is to generate the first complementary pattern to enable the detection of a nozzle health issue, or is to generate the first complementary pattern to enable the detection of a printhead alignment issue.

4. The system of claim 3, wherein the controller is cause the first complementary pattern to enable the detection of a nozzle health issue to be printed by any of the nozzles of a printhead, and wherein the controller is cause the first complementary pattern to enable the detection of a printhead alignment issue to be printed by a set of overlapping nozzles of two adjacent printheads.

5. The system of claim 4, wherein the controller keeps track of the time when the health of each nozzle and/or the printhead alignment was verified, and determines the type of the sub-pattern based and the nozzles used to print it based on the age of the verification.

6. The system of claim 1, wherein the first complementary pattern comprises a continuous line to be printed by a single nozzle.

7. The system of claim 3, wherein the first complementary pattern comprises a continuous line portions of which are to be printed by different ones of a pair of corresponding and overlapping nozzles.

8. The system of claim 1, wherein the controller is to determine whether a printhead service issue exists and to perform a printhead maintenance operation prior to causing the printhead to print the second complementary pattern.

9. The system of claim 3, wherein the controller is to generate the first sub-pattern to comprise a portion of the complete pattern and a pattern suitable to allow identification of a printhead health issue or a printhead alignment issue.

10. The system of claim 1, wherein the printer is a three-dimensional printer, and wherein the target is a layer of powder formed on a movable build platform.

11. The system of claim 1, wherein the printer is two-dimensional printer and wherein the target is a sheet of print media.

12. The system of claim 10, wherein the intended pattern is one of a set of intended patterns each representing layers of an object model of a three-dimensional object to be printed.

13. A method of detecting printhead issues in a printer, comprising:
obtaining an image to be printed;
generate a first sub-pattern and a second sub-pattern, wherein the first sub-pattern in a pattern to be printed in a first pass comprising a pattern suitable to enable the detection of a printhead issue and wherein the second sub-pattern is the complementary pattern that completes the first sub-pattern such that printing the first and second sub-patterns is equivalent to printing the obtained image;
printing the first sub-pattern on a print target;
obtaining an image of the printed first sub-pattern;
analysing the image of the printed first sub-pattern to determine the presence of a printhead issue and, where appropriate, performing a printhead maintenance operation; and
printing the second sub-pattern on the print target.

14. The method of claim 13, wherein the printer comprises an array of semi-overlapping printheads, and wherein the first sub-pattern comprises a pattern suitable to detect a nozzle health issue or a printhead alignment issue.

15. The method of claim 14, wherein the first sub-pattern comprises a portion of the image to be printed.
